(19) United States
(12) Patent Application Publication
(10) Pub. No.: US 2014/0330625 A1
(43) Pub. Date: Nov. 6, 2014

(54) ITEMS REFERRALS IN A NETWORK-BASED PUBLICATION SYSTEM

(71) Applicant: Mark D. Yuan, San Mateo, CA (US)

(72) Inventor: Mark D. Yuan, San Mateo, CA (US)

(73) Assignee: eBay Inc., San Jose, CA (US)

(21) Appl. No.: 13/886,723

(22) Filed: May 3, 2013

(51) Int. Cl. G06Q 30/06

(52) U.S. Cl. CPC G06Q 30/0631
USPC 705/14.16; 705/26.62

(57) ABSTRACT

Methods and systems for facilitating the referrals of items provided by a network-based publication system are described. In some example embodiments, the methods and systems may provide a mechanism to receive referrals from viewers of items (e.g., viewers of product description information associated with items available for purchase) and/or surface items that have been referred to other viewers looking to purchase items via the network-based publication system.

### TECHNICAL FIELD

This application relates generally to information retrieval, and specifically, to a system and method for facilitating item referrals in a network-based publication system.

### BACKGROUND

Merchandising of items for sale via a network-based merchandising or publication system is well-known. Many websites accessible via the Internet are operated as online stores or auctions. These websites enable users to purchase items that may be physical items (e.g., an article of clothing), electronic data items (e.g., a downloadable digital media product), or services to be rendered by an affiliated service provider. To facilitate potential transactions and thereby improve user experiences, some websites provide recommendations of items to users. Often, a network-based merchandising system will enable users to search for items available for purchase, such as by received keywords and identifying items that include descriptions that match some or all of the keywords.

### BRIEF DESCRIPTION OF THE DRAWINGS

The present technology is illustrated by way of example, and not by way of limitation, in the figures of the accompanying drawings.

FIG. 1 is a block diagram illustrating a network architecture of a system used to facilitate item referrals in a network-based publication system, in some example embodiments.

FIG. 2 is a block diagram illustrating a publication system of available items, in some example embodiments.

FIG. 3 is a display diagram illustrating an example user interface associated with receiving a referral for an item, in some example embodiments.

FIG. 4 is a display diagram illustrating an example user interface associated with presenting a referred item along with a listing of items, in sonic example embodiments.

FIG. 5 is a flow diagram illustrating a method for locating referred items, in some example embodiments.

FIG. 6 is a block diagram illustrating a network architecture of a system used to facilitate item referrals across multiple online locations, in some example embodiments.

FIG. 7 is a flow diagram illustrating a method for presenting referred items from multiple online locations, in some example embodiments.

FIG. 8 is a display diagram illustrating an example user interface associated with presenting information associated with referred items, in some example embodiments.

FIG. 9 is a flow diagram illustrating a method for performing an action or a referrer of an item, in some example embodiments.

FIG. 10 shows a diagrammatic representation of a machine in the example for of a computer system within which a set of instructions may be executed to cause the machine to perform any one or more of the methodologies discussed herein.

### DETAILED DESCRIPTION

### Overview

Methods and systems for facilitating the referrals of items provided by a network-based publication system are described. The methods and systems may provide a mechanism to receive referrals from viewers of items (e.g., viewers of product description information associated with items available for purchase) and/or to surface, identify, or present items that have been referred to other viewers looking to purchase items via the network-based publication system.

In some example embodiments, the methods and systems receive a request for one or more items provided by a network-based publication system that satisfy search criteria associated with the request, access referral information for items provided by the network-based publication system that satisfy the search criteria, and surface one or more items based on the accessed referral information. For example, the methods and systems may surface one or more items that have receive referrals and/or endorsements from a certain number of users of the network-based publication system, from certain users (e.g., top referrers), and so on.

In some example embodiments, the methods and systems may receive a referral of an item from a viewer of product description information associated with the item and presented by the network-based publication system, determine the item has been purchased via the network-based publication system, and perform an action (e.g., provide a reward) associated with the viewer that provided the referral of the item.

In some example embodiments, the methods and systems may aggregate referrals of items provided by multiple different online and/or offline locations (e.g., one or more online retailers, one or more item listing locations, one or more physical locations, and so on), and present a user with a listing of referred items from the various different locations.

Thus, the methods and systems enable a network-based publication system, or other systems, to present a user with available products that have been referred or otherwise endorsed by other users, which enables the user to leverage the viewing/browsing behaviors of many other users of the network-based publication system in order to identify, find, and/or uncover items that may be of interest to the user but have been buried within a long tail of items provided by the network-based publication system, among other things.

### Example System

In the following description, for purposes of explanation, numerous specific details are set forth in order to provide a thorough understanding of the present disclosure. It may be evident, however, to one skilled in the art that the subject matter of the present disclosure may be practiced without these specific details.

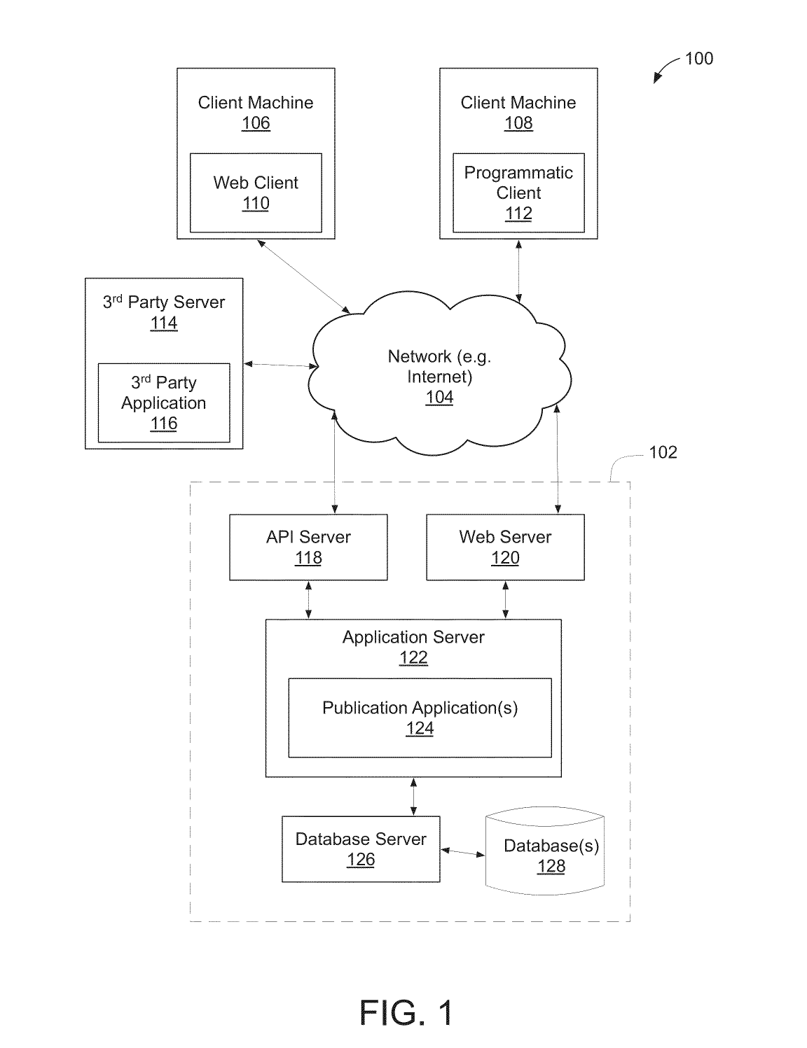

FIG. 1 is a block diagram illustrating the architecture of a network system 100 used to facilitate item referrals, in some example embodiments. The network system 100 may include a network-based publication/publisher system 102 where clients may communicate and exchange data within the network system 100. The data may pertain to various functions (e.g., selling and purchasing of items, receive and presenting referrals) and aspects (e.g., data describing items listed on the publication/publisher system) associated with the network system 100 and its users. Although illustrated herein as a client-server architecture as an example, other example embodiments may include other network architectures, such as a peer-to-peer or distributed network environment.

A data exchange platform, in an example form the network-based publisher system 102, may provide server-side functionality, via a network 104 (e.g., the Internet) to one or more clients. The one or more clients may include users that utilize the network system 100 and more specifically, the network-based publisher system 102, to exchange data over the network 104. These transactions may include transmitting, receiving (communicating), and processing data to, from, and regarding content and users of the network system 100. The data may include, but are not limited to, content and user data such as feedback data; user reputation values; user profiles; user attributes; product and service reviews; product, service, manufacturer, and vendor recommendations and identifiers; product and service listings associated with buyers and sellers; auction bids; referrals and endorsements; and transaction data; among other things.

In various embodiments, the data exchanges within the network system 100 may be dependent upon user-selected functions available through one or more client or user interfaces (UIs). The UIs may be associated with a client machine, such as a client machine 106 using a web client 110. The web client 110 may be in communication with the network-based publisher system 102 via a web server 120. The UIs may also be associated with a client machine 108 using a programmatic client 112, such as a client application, or a third party server 114 hosting a third party application 116. It can be appreciated that in various embodiments the client machine 106, 108, or third party application 114, may be associated with a buyer, a seller, a third party electronic commerce platform, a payment service provider, or a shipping service provider, each in communication with the network-based publisher system 102 and optionally each other. The buyers and sellers may be any one of individuals, merchants, or service providers, among other things.

Turning to the network-based publisher system 102, an application program interface (API) server 118 and a web server 120 are coupled to, and provide programmatic and web interfaces respectively to, one or more application servers 122. The application servers 122 host one or more publication application(s) 124. The application servers 122 are, in turn, shown to be coupled to one or more database server(s) 126 that facilitate access to one or more database(s) 128.

In some example embodiments, the web server 120 and the API server 118 communicate and receive data pertaining to listings, transactions, and feedback, among other things, via various user input tools. For example, the web server 120 may send and receive data to and from a toolbar or webpage on a browser application (e.g., web client 110) operating on a client machine (e.g., client machine 106). The API server 118 may send and receive data to and from an application (e.g., programmatic client 112 or third party application 116) running on another client machine (e.g., client machine 108 or third party server 114).

The publication application(s) 124 may provide a number of publisher functions and services (e.g., search, listing, payment, etc.) to users that access the network-based publisher system 102. For example, the publication application(s) 124 may provide a number of services and functions to users for listing goods and/or services for sale, searching for goods and services, facilitating transactions, and reviewing and providing feedback about transactions and associated users. Additionally, the publication application(s) 124 may track and store data and metadata relating to listings, transactions, referrals, and user interactions with the network-based publisher system 102.

FIG. 1 also illustrates a third party application 116 that may execute on a third party server 114 and may have programmatic access to the network-based publisher system 102 via the programmatic interface provided by the API server 118. For example, the third party application 116 may use information retrieved from the network-based publisher system 102 to support one or more features or functions on a website hosted by the third party. The third party website may, for example, provide one or more listings, feedback, and publisher or payment functions that are supported by the relevant applications of the network-based publisher system 102.

While the example network system 100 of FIG. 1 employs a client-server architecture, a skilled artisan will recognize that the present disclosure is not limited to such an architecture. The example network system 100 can equally well find application in, for example, a distributed or peer-to-peer architecture system.

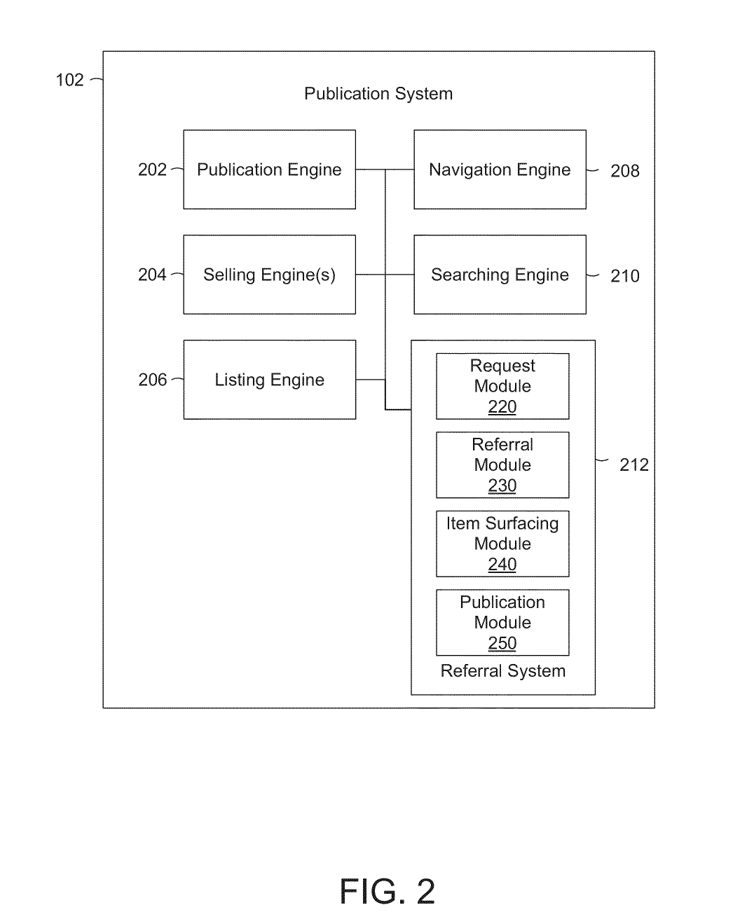

Referring now to FIG. 2, an example block diagram illustrating multiple components that, in some example embodiments, are provided within the network-based publisher/publication system 102 of the networked system 100 is shown. The publication system 102 may be hosted on dedicated or shared server machines (not shown) that are communicatively coupled to enable communications between the server machines. The multiple components, themselves, are communicatively coupled (e.g., via appropriate interfaces), either directly or indirectly, to each other and to various data sources, to allow information to be passed between the components or to allow the components to share and access common data. Furthermore, the components may access the one or more database(s) 128 via the one or more database servers 126, both shown in FIG. 1.

In some example embodiments, the publication system 102 comprises a network-based marketplace and provides a number of publishing, listing, and price-setting mechanisms whereby a seller (e.g., business or consumer) may list (or publish information concerning) goods or services for sale, a buyer can search for, express interest in, or indicate a desire to purchase such goods or services, and a price can be set for a transaction pertaining to the goods or services. To this end, the publication system 102 may comprise at least one publication engine 202 and one or more selling engines 204. The publication engine 202 may publish information, such as item listings or product description pages, on the publication system 102. In some example embodiments, the selling engines 204 may comprise one or more auction engines that support auction-format listing and price setting mechanisms (e.g., English, Dutch, Chinese, Double, Reverse auctions, and so on). The various auction engines may also provide a number of features in support of these auction-format listings, such as a reserve price feature whereby a seller may specify a reserve price in connection with a listing and a proxy-bidding feature whereby a bidder may invoke automated proxy bidding.

A listing engine 206 allows sellers to conveniently author listings of items or authors to author publications. In some example embodiments, the listings pertain to goods or services that a user (e.g., a seller) wishes to transact via the publication system 102. Each good or service is associated with a particular category. The listing engine 206 may receive listing data such as title, description, and aspect name/value pairs. Furthermore, each listing for a good or service may be assigned an item identifier. In some example embodiments, a user may create a listing that is an advertisement or other form of information publication. The listing information may then be stored to one or more storage devices coupled to the publication system 102 (e.g., databases 128). Listings also may comprise product description pages that display a product and information (e.g., product title, specifications, reviews, and so on) associated with the product. In some example embodiments, the product description page may include an aggregation of item listings that correspond to the product described on the product description page.

In a further example, a navigation engine 208 allows users to navigate through various categories, catalogs, or inventory data structures according to which listings may be classified within the publication system 102. For example, the navigation engine 208 allows a user to successively navigate down a category tree comprising a hierarchy of categories until a particular set of listings is reached. Various other navigation applications within the navigation engine 208 may be provided to supplement the searching and browsing applications. The navigation engine 208 may record the various user actions (e.g., clicks) performed by the user in order to navigate down the category tree.

A searching engine 210 may facilitate searching the network-based publication system 102. For example, the searching engine 210 enables keyword queries of listings published via the publication system 102 and/or image queries of images associated with the listings published via the publication system 102. In some example embodiments, the searching engine 210 receives the image queries from a computing or mobile device associated with a user (e.g., client machine 106 or 108) and conducts a review of the storage device storing the listing information. The review will enable compilation of a results set of listings that may be sorted and returned to the client device (e.g., client machine 106 or 108) associated with the user. The searching engine 210 may record the query and any subsequent user actions and behaviors (e.g., navigations)

### The Referral System

In some example embodiments, a referral system 212 facilitates receiving referrals and providing or presenting referrals of available items published by and/or on the network-based publication system 102. The referral system 212 may include various modules. The modules may be hardware, software, or a combination of hardware and software. The modules may be executed by one or more processors. For example, the referral system 212 may include a request module 220, a referral module 230, an item surfacing module 240, and a publication module 250.

In some example embodiments, the request module 220 is configured and/or programmed to receive a request for one or more items provided by the network-based publication system 102 that satisfy search criteria associated with the received request. For example, the request module 220 may receive a request from a user of the network-based publication system 102 to present items that satisfy search criteria (e.g., items associated with product description information that satisfies a received search query) and have been referred and/or endorsed. As another example, the request module 220 may receive the request from the searching engine 210 and/or the listing engine 206, such as when the searching engine 210 receives and/or satisfies a query of available items, when the listing engine 206 publishes a listing or listings of product description information associated with available items, and so on.

The received request may identify and/or include the search criteria as well as instructions to identify items that are associated with referrals and/or endorsements from users of the network-based publication system 102. For example, the request may include instructions to identify and/or select items having a certain, or at least a minimum, number of referrals, items having a certain, or at least a minimum, referral ranking, items associated with referrals from certain referrers (e.g., other users), and so on.

In some example embodiments, the referral module 230 is configured and/or programmed to access referral information for items provided by the network-based publication system 102 that satisfy the search criteria, such as referral information that is based on and/or includes referrals received from viewers of product description information associated with the items provided by the network-based publication system 102.

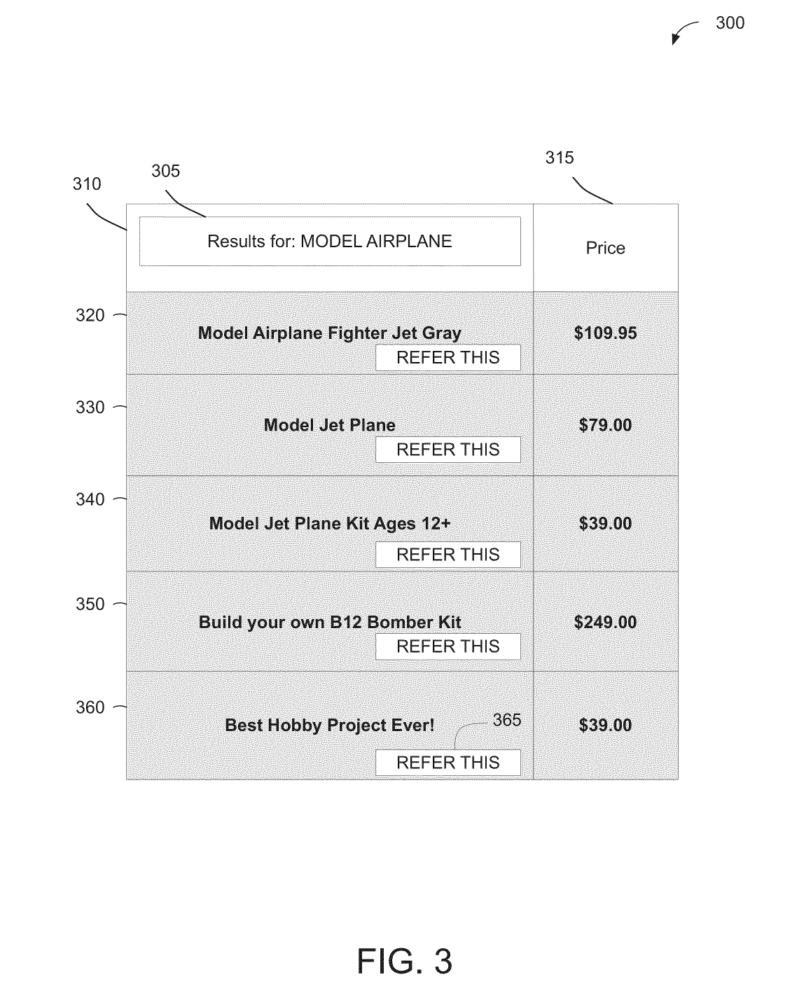

For example, the publication system 102 may facilitate the reception of referral input from users via product listing pages that present product description information associated with items available for purchase from the publication system 102. FIG. 3 is a display diagram illustrating an example user interface 300 associated with receiving a referral for an item, in some example embodiments.

The user interface 300 may include a results page 310 that presents product listings 320-360 that satisfy a received search query 305 (e.g., “model airplane”). The product listings 320-360 may include description information (e.g., listing 320 is described as “model airplane fighter jet gray”) as well as price information 315, and so on. The user interface 300 also displays user-selectable buttons or graphical elements 365 that, when selected by a viewer of the product page 310, facilitate the reception of a referral for an item associated with the presented listing 320-360. For example, upon receiving a selection of the “refer this” button 365 for listing 360, the “best hobby project ever!” listing, from a viewer, the referral system 212 considers the items associated with listing 360 as referred and/or endorsed items. In response to the received selection, the referral system 212 may update a data structure (e.g., Table 1) to include information identifying the item, information updating the number of referrals, information identifying the referrer (e.g., the user who selected button 365), and so on.

In some example embodiments, the referral module 230 may access referral information associated with rankings that are based on a quantity of referrals received by the network-based publication system 102 from viewers of product description information associated with the items and/or referral information associated with rankings that are based on a quality metric assigned to viewers of product description information associated with the items that provided referrals for the items.

The referral system 212 may rank available items based on the quantity and/or quality of referrals associated with an item. The rankings may reflect the position of an item across all available items provided by the publication system 102, the position of an item across available items with a certain product category (e.g., books, shoes, and so on), the position of an item across all items that satisfy search criteria, and so on. The referral system 212, therefore, may generate and/or store a table or other data structure that includes, for some or all items, information associated with referrals for the items. As an example, the following table (Table 1) depicts some information the referral system 212 may store for available items (e.g., items in a sports memorabilia category that satisfy the search criteria of “Mickey Mantle”) provided by the publication system 102:

TABLE 1

| | | Quality metric | Overall |
|---|---|---|---|
| Item | # of referrals | (1-10) | ranking |
| Mantle signed photo | 3 | 9.5 | 1 |
| Mantle Jersey | 1 | 10 | 2 |
| Mantle Jersey - Road | 2 | 7 | 3 |
| Mickey Mantle Lunchbox | 6 | 4.5 | 4 |

As shown in the table, each entry relates an item to various referral information, such as a number of referrals, a quality metric assigned to the referrals (e.g., referrers who have previously referred items that were later purchased or are selective with referrals may cause the metric to be high, whereas referrers who provide a lot of unused referrals may cause the metric to be low), a referral ranking based on the number of referrals and/or the quality metric, and so on. Of course, the table may include other information types (e.g., ranking by category, other quantitative and qualitative metrics, and so on) not shown. The referral module 230, therefore, may access such a data structure and the information contained therein when identifying items that have been referred by others users, among other things.

Referring back to FIG. 2, in some example embodiments, the item surfacing module 240 is configured and/or programmed to surface one or more of the items based on the accessed referral information. For example, the item surfacing module 240 may surface and/or cause the listing engine 206 to present and/or display some or all referred items that satisfy a search query and/or request to publish items.

In some example embodiments, the surfacing module 240 may surface and/or publish items assigned comparatively high rankings, such as items that have received a certain number of referrals, items associated with referrals received from certain users (such as users associated with high quality referrals), items receiving referrals from viewers of product description information associated with the items within a certain time period (e.g., referrals received within the most recent week), and so on.

In some example embodiments, the surfacing module 240 may surface and/or publish items based on characteristics associated with the user of the network-based publication system. For example, the surfacing module 240 may identify referred items that match certain characteristics of the user (e.g., the seller of the item is located where the user is located), items associated with categories targeted to the user, and so on.

In some example embodiments, the publication module 250 is configured and/or programmed to publish, via a user interface provided by the network-based publication system 102, product description information associated with the one or more surfaced items along with product description information for other items provided by the network-based publication system that satisfy search criteria associated with the received request.

In some example embodiments, the surfacing module 240 may surface and/or publish a list of referred items that a user of the network-based publication system 102 has referred or endorsed. Each user may be associated with one or more referral lists, which each may be publicly or privately accessible to other users via the Internet generally or via the network-based publication system. The surfacing module 240 may enable discovery of the referral lists through multiple channels such as in a search results page, from an item listing page, or from a product description page, among other things. The surfacing module 204 also may rank, spotlight or feature one or more selected lists for users. The referral lists may reflect a referrer's ability to find neglected, buried, or otherwise under-publicized items. The referral lists may be capable of being saved, bookmarked, shared, or otherwise noted by users.

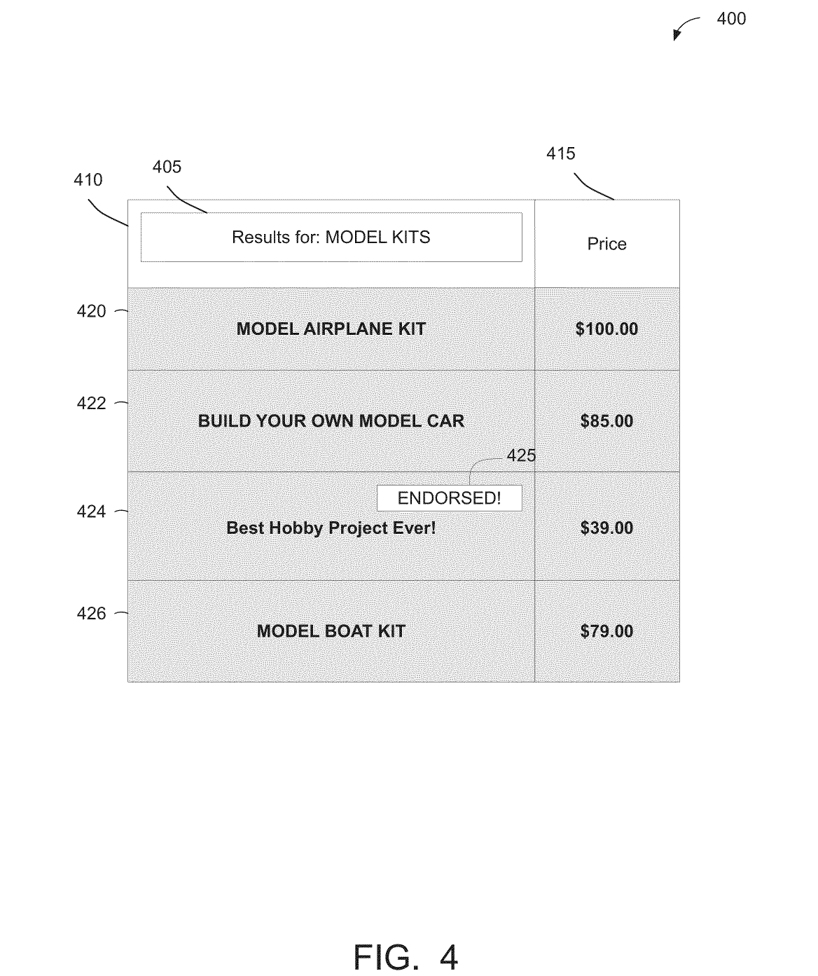

For example, FIG. 4 is a display diagram illustrating an example user interface 400 associated with presenting a referred item along with a listing of items, in some example embodiments. The user interface 400 presents a results page 410 that includes listing of results 420-426, which include titles and price information 415, that satisfy a search query 405 (e.g., “model kits”), received from a user. The results page 410 includes various results 420, 422, 424, and 426 that include titles (e.g., “model airplane kit” for results 420) having words that match some of the keywords in the received query 405, and a listing 424 that includes a title, “best hobby project ever!” that does not include words that match the query. However, as shown in the listing 424 with element 425 (“endorsed!”), listing 424 represents a referred item, and is presented along with other listings in the results page 410. Therefore, despite the listing 424 including a title somewhat unrelated to the search query, the item associated with the listing 424 is a referred item, and the listing engine 206 causes the listing 424 to be displayed along with the top results for the received query 405.

Although the various components of the publication system 102 have been discussed in terms of a variety of individual modules and engines, a skilled artisan will recognize that many of the components can be combined or organized in other ways. Furthermore, not all components of the publication system 102 have been included in FIG. 2. In general, components, protocols, structures, and techniques not directly related to functions of example embodiments (e.g., dispute resolution engine, loyalty promotion engine, reputation engines, listing management engines, account engine) have not been shown or discussed in detail. The description given herein simply provides a variety of example embodiments to aid the reader in an understanding of the systems and methods used herein.

### Surfacing Referred Items

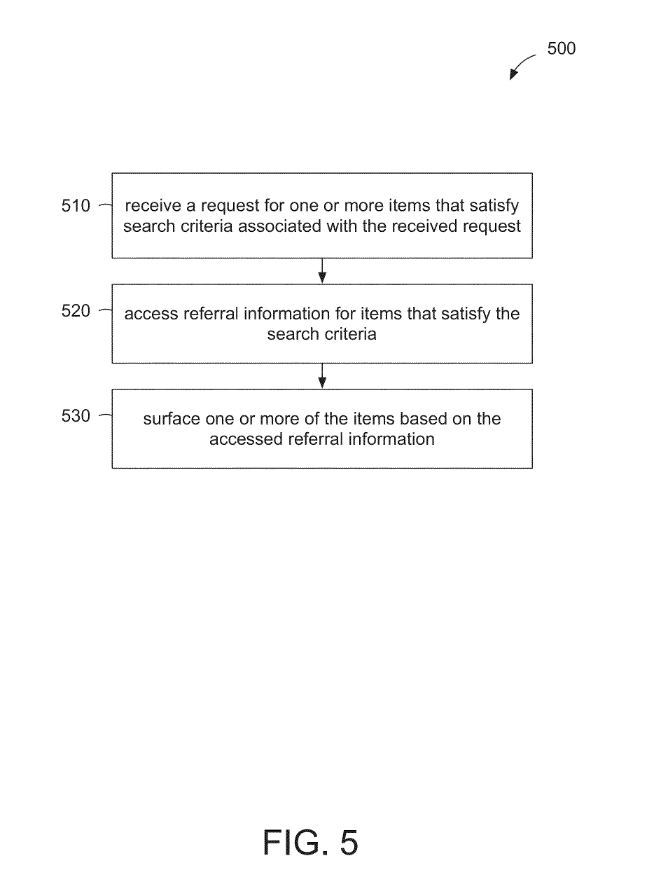

As described herein, in some example embodiments, the referral system 212 receives a request to present items that satisfy a search criteria, and surfaces various referred items that satisfy the request, among other things. FIG. 5 is a flow diagram illustrating a method 500 for locating referred items, in some example embodiments. The method 500 may be performed by the referral system 212 and, accordingly, is described herein merely by way of reference thereto. It will be appreciated that the method 500 may be performed on any suitable hardware.

In operation 510, the referral system 212 receives a request for one or more items provided by a network-based publication system that satisfy search criteria associated with the received request. For example, the request module 220 may receive a request from a user of the network-based publication system 102 to present items that satisfy search criteria (e.g., items associated with product description information that satisfies a received search query) and have been referred and/or endorsed (e.g., previously endorsed, tagged, and/or flagged by a user). As another example, the request module 220 may receive the request from the searching engine 210 and/or the listing engine 206, such as when the searching engine 210 receives and/or satisfies a query of available items, when the listing engine 206 publishes a listing or listings of product description information associated with available items, and so on.

In operation 520, the referral system 212 accesses referral information for items provided by the network-based publication system that satisfy the search criteria. For example, the referral module 230 may access the referral information described herein, such as referral information that is based on and/or includes referrals received from viewers of product description information associated with the items provided by the network-based publication system 102. The referrals may be received, from viewers that selected a referral user interface element (e.g., button 365 of FIG. 3) associated with a listing for an item, from users of a social network that endorsed and/or promoted the items, and so on.

In operation 530, the referral system 212 surfaces one or more of the items based on the accessed referral information. For example, the item surfacing module 240 may surface and/or publish items assigned comparatively high rankings, such as items that have received a certain number of referrals, items associated with referrals received from certain users (such as users associated with high quality referrals), items receiving referrals from viewers of product description information associated with the items within a certain time period (e.g., referrals received within a most recent week), and so on.

As described herein, in some example embodiments, the referral system 212 may publish, via a user interface provided by the network-based publication system, product description information associated with the one or more surfaced items along with product description information for other items provided by the network-based publication system that satisfy search criteria associated with the received request. For example, the referral system 212 may publish referred items along with top results for search queries, enabling the network-based publication system 102 to identify and present long tail inventory items along with more popular items, among other things.

### Presenting Referrals For Items Provided at Multiple Locations

As described herein, in some example embodiment, the referral system 212 may provide a user interface, via a webpage or stand-alone application, which presents listings fir referred items across multiple locations, among other things.

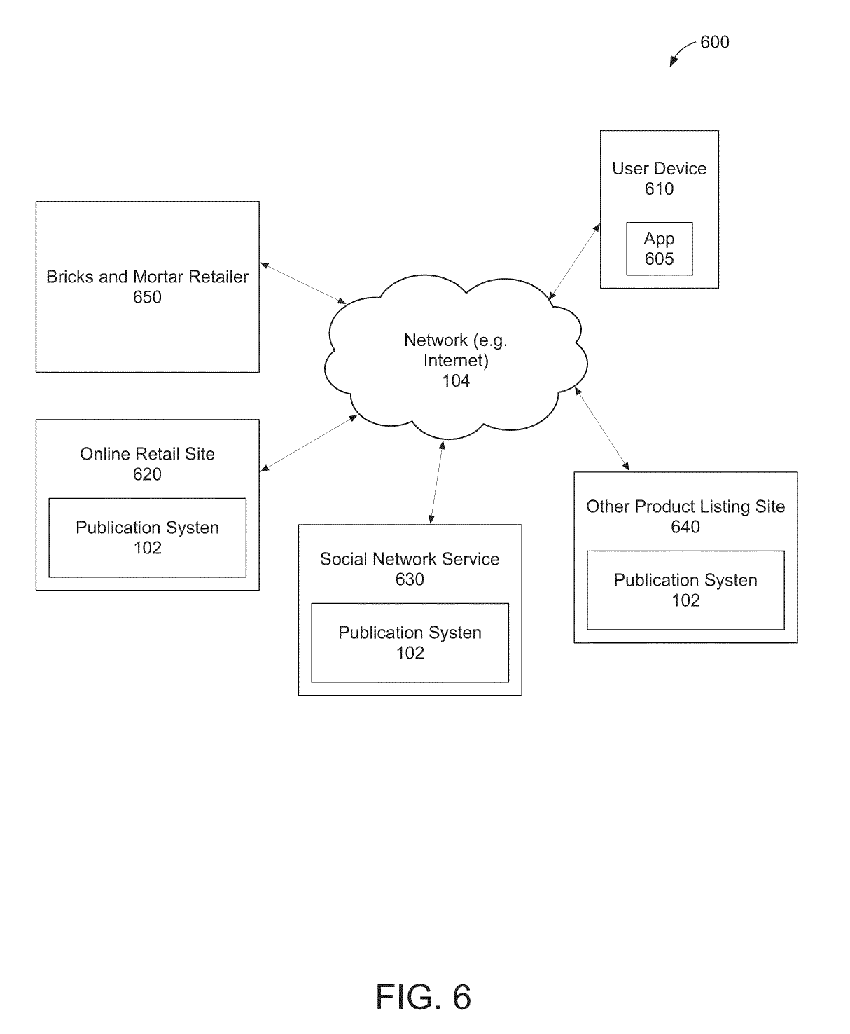

FIG. 6 is a block, diagram illustrating a network architecture of a system 600 used to facilitate the reception and/or presentation of item referrals across multiple online locations, in some example embodiments. The multiple location system 600 includes a user device 610 (e.g., client machine 106 or 108) supporting an application or web browser 605 (e.g., web client 110 or programmatic client 112). The application 605 may include and/or communicate across the network 104 with the referral system 212 and/or the publication system 102. The application 605 may also communicate with various online and offline locations over the network 104, such as an online retail site 620 that includes aspects of the publication system 102, a social network service 630 that includes aspects of the publication system 102, and/or other product listing sites 640 that include aspects of the publication system 102. The application 605 may also receive information from a bricks and mortar retailer 650 or other physical location, such as information (e.g., images and other content) captured of products available for purchase via the retailer.

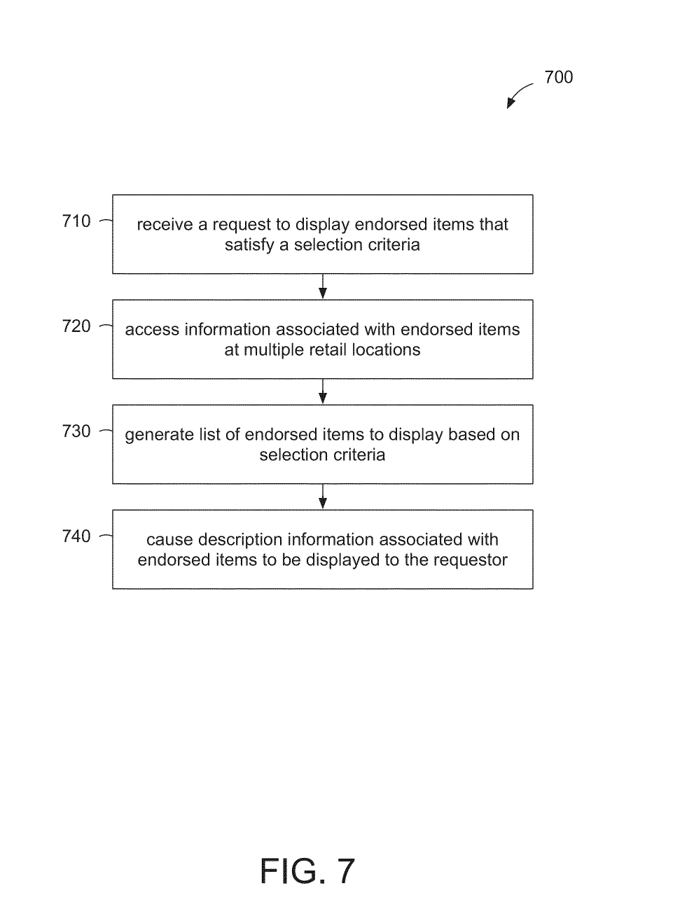

As described herein, the referral system 212 may facilitate the reception and/or presentation of referrals for items provided by multiple locations, among other things, FIG. 7 is a flow diagram illustrating a method 700 for presenting referred items from multiple online locations, in some example embodiments. The method 700 may be performed by the referral system 212 and, accordingly, is described herein merely by way of reference thereto. It will be appreciated that the method 700 may be performed on any suitable hardware.

In operation 710, the referral system 212 receives a request to display endorsed and/or referred items that satisfy selection criteria. For example, the request module 220 may receive a request from a user to present items that satisfy search criteria (e.g., items associated with product description information that satisfies a received search query) and have been referred and/or endorsed.

In operation 720, the referral system 212 accesses information associated with endorsed items at multiple retail locations, such as information that identifies, describes, and/or represents items that have been endorsed by users of the retail locations. For example, the referral module 230 may query data structures at various locations (e the online retail site 620, the social network service 630, and/or other product listing sites 640) to identify items that have been referred by users of the respective sites.

In operation 730, the referral system 212 generates a list of endorsed items to display based on selection criteria. For example, the referral system 212 may receive, as part of the request, various selection criteria, and generate a list of referred items that satisfy the criteria. Example selection criteria may include criteria associated with a category of items, criteria associated with a price of items, criteria associated with a location of items, criteria associated with a type of online product publisher, criteria associated with a time period of referral for the items, criteria associated with a referral ranking assigned to the items, search criteria, and so on.

In operation 740, the referral system 212 causes description information that describes, represents and/or is otherwise associated with endorsed items, such as product description information, to he displayed to the requestor. For example, the referral system 212 may cause a user interface provided by the application 605 of the user device 610 to present a listing of product description information for items that satisfied the selection criteria.

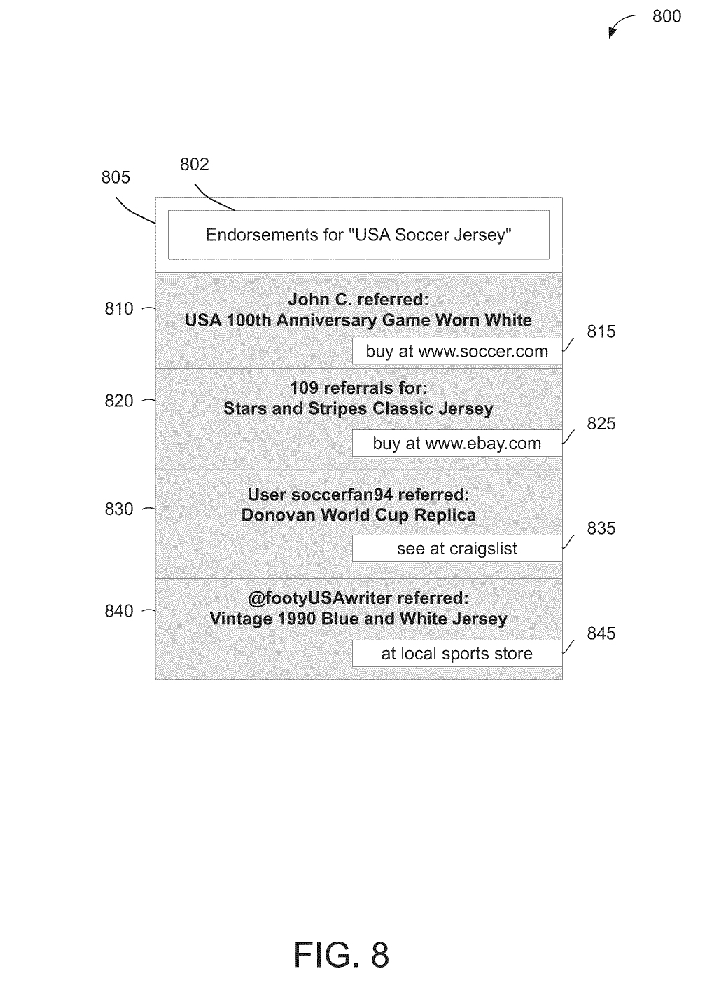

FIG. 8 is a display diagram illustrating an example user interface 800 that presents information, such as product description information, for referred items, in some example embodiments. The user interface 800 depicts a page 805 that presents various listings 810-840 that satisfy a selection criterion 802 of “USA Soccer Jersey” for referred items across various online and offline retail locations.

The page 805 presents listings for items provided by multiple locations. Each listing presents product description information for referred items, information identifying the referrer, and a user-selectable button that facilitates the purchase of the referred items via the location providing the referred items. For example, the page 805 includes:

A listing 810 presenting an item entitled “USA 100^{th} Anniversary Game Worn White,” which was referred by a friend of the user, along with a user-selectable button 815 configured to facilitate the purchase of the referred item via an online retailer (e.g., www.soccer.com) that is providing the item;

A listing 820 presenting an item entitled “Stars and Stripes Classic Jersey,” which was referred by 109 viewers, along with a user-selectable button 825 configured to facilitate the purchase of the referred item via an online publisher (e.g., www.ebay.com) that is providing the item;

A listing 830 presenting an item entitled “Donovan World Cup Replica,” which was referred by a top referrer, along with a user-selectable button 835 configured to facilitate the purchase of the referred item via an online listing site (e.g., www.craigslist.org) that is providing the item; and

A listing 840 presenting an item entitled “Vintage 1990 Blue and White Jersey,” which was referred by a twitter user, along with a user-selectable button 845 configured to facilitate the purchase of the referred item at a physical location (e.g., a local sports store) that is providing the item. Of course, the page 805 may include other information not shown in the Figure.

Thus, in some example embodiments, the referral system 212 may provide and/or be part of an application that presents various listings of referred items provided by multiple locations across a network. Such a system may enable a user to receive listing information for items provided by various different locations that are referred and/or endorsed by viewers and/or other users of the locations, among other things,

### Providing Incentives to Referrers of Items

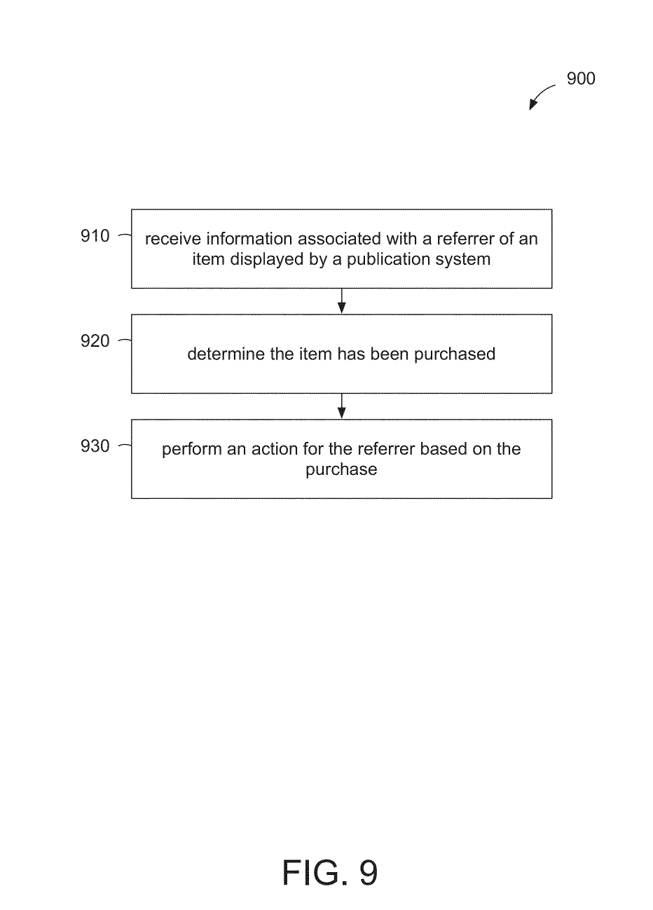

As described herein, in some example embodiments, the referral system 212 may perform actions associated with referrers of items, to encourage users and viewers of product listings to browse listings in order to identify interesting or exceptional items that may be referred and/or endorsed, among other things. FIG. 9 is a flow diagram illustrating a method 900 for performing an action for a referrer of an item, in some example embodiments. The method 900 may be performed by the referral system 212 and, accordingly, is described herein merely by way of reference thereto. It will be appreciated that the method 900 may be performed on any suitable hardware.

In operation 910, the referral system 212 receives a referral of an item from a viewer of product description information associated with the item presented by a network-based publication system. For example, the referral system 212 may receive an indication that a viewer selected a referral user interface element (e.g., button 365 of FIG. 3) associated with a listing for an item, may receive an indication that a user of a social network that endorsed and/or promoted the item, and so on.

In operation 920, the referral system 212 determines a user of the network-based publication system has purchased the item. For example, the referral system 212 may receive information from the network-based publication system 102 that the item was purchased.

In operation 930, the referral system 212 performs an action associated with the viewer that provided the referral of the item based on the determination that the item has been purchased. For example, the referral system 212 may provide a reward to the user that provided the referral of the item, such as a percentage of the purchase price, a coupon to purchase other items at a discount, a gift, an endorsement of the user, and so on.

In some example embodiments, in the event multiple referrers have referred the same item that was purchased, the referral system 212 may provide the reward to the user who first referred the item on the network-based publication system. In some example embodiments, the referral system 212 may use a tiered reward system to provide a first reward to the user who first referred the item, a second reward to a second user who referred the item subsequent to the user, a third reward to a third user who referred the item subsequent to the user and the second user, and so forth. The first reward may be larger or more valuable than the second reward, which in turn, may be larger or more valuable than the third reward, and so forth. In some example embodiments, the referral system 212 may provide a larger or more valuable reward to a user other than the first referrer if the purchase can be traced to the referral of the non-first referring user. For example, the purchase of the item by the purchaser may be attributable to a social connection between the purchaser and the non-first referring user.

In some example embodiments, the referral system 212 may store information associated with the referrers of items. For example, the referral system 212 may facilitate and/or provide contests to identify top referrers, such as referrers associated with items that have been purchased, referrers that have received the most endorsements, and so on.

Thus, in some example embodiments, the referral system 212 may perform actions that encourage users to browse or otherwise navigate product listings of the network-based publication system 102 in order to provide referrals for items that the user wish to be presented to other users, among other things.

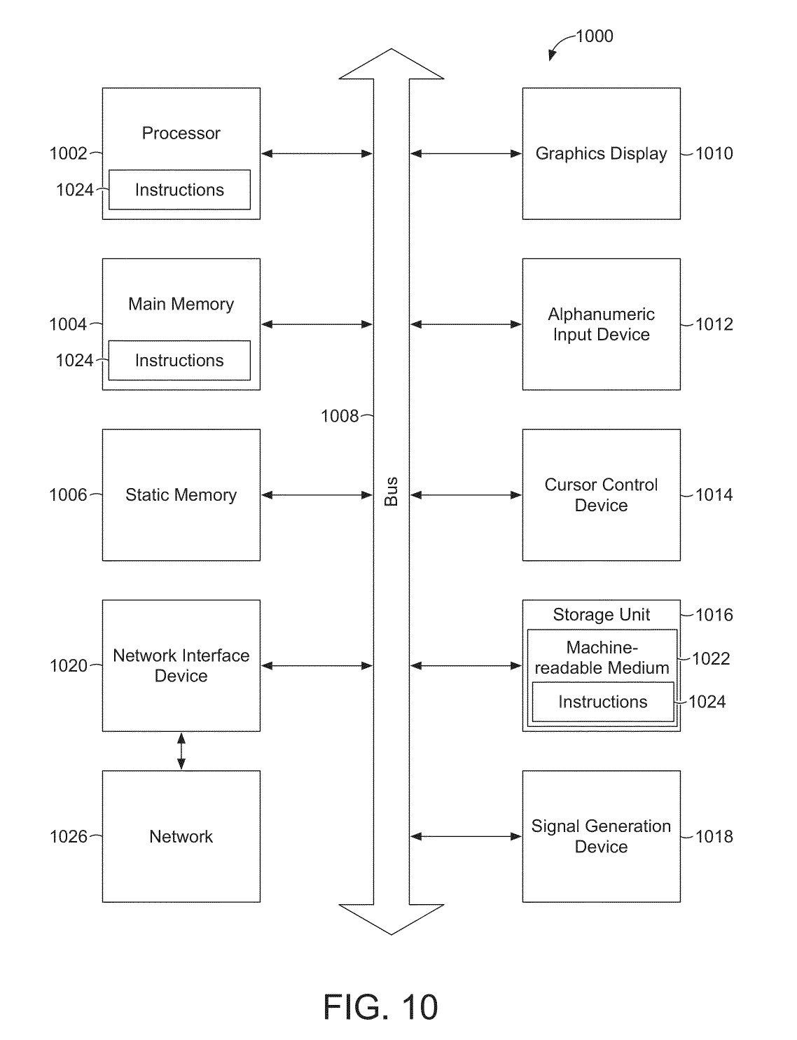

FIG. 10 shows a diagrammatic representation of machine in the exemplary form of a computer system 1000 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a personal digital assistant (PDA), a tablet, a mobile device such as a cellular telephone or smart phone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU) a graphics processing unit (GPU) or both), a main memory 1004 and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard), a cursor control device 1014 (e.g., a mouse), a disk drive unit 1016, a signal generation device 1018 (e.g., a speaker) and a network interface device 1020.

The disk drive unit 1016 includes a machine-readable medium 1022 on which is stored one or more sets of instructions (e.g., software 1024) embodying any one or more of the methodologies or functions described herein. The software 1024 may also reside, completely or at least partially, within the main memory 1004 and/or within the processor 1002 during execution thereof by the computer system 1000, with the main memory 1004 and the processor 1002 also constituting machine-readable media. The software 1024 may further be transmitted or received over a network 1026 via the network interface device 1020.

While the machine-readable medium 1022 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any one or more of the methodologies of the present disclosure. The term “machine-readable medium” shall accordingly be taken to include, but not be limited to, solid-state memories, optical and magnetic media, and other storage media.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

Although the present disclosure has been described with reference to specific exemplary embodiments, it may be evident that various modifications and changes may be made to these embodiments without departing from the broader spirit and scope of the disclosure. Accordingly, the specification and drawings are to be regarded in an illustrative rather than a restrictive sense.

The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to he taken in a limiting sense, and the scope of various embodiments is defined only by the appended claims, along with the full range of equivalents to which such claims are entitled.

Such embodiments of the inventive subject matter may be referred to herein, individually, and/or collectively, by the term “invention” merely for convenience and without intending to voluntarily limit the scope of this application to any single technology, embodiment, or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The preceding technical disclosure is intended to be illustrative, and not restrictive. For example, the above-described embodiments (or one or more aspects thereof) may be used in combination with each other. Other embodiments will be apparent to those of skill in the art upon reviewing the above description.

In this document, the terms “a” or “an” are used, as is common in patent documents, to include one or more than one. In this document, the term “or” is used to refer to a nonexclusive or, such that “A or B” includes “A but not B,” “B but not A,” and “A and B,” unless otherwise indicated. Furthermore, publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

What is claimed is:

1. A system, comprising:
a request module that is configured to receive a request for one or more items provided by a network-based publication system that satisfy search criteria associated with the received request;
a referral module that is configured to access referral information for items provided by the network-based publication system that satisfy the search criteria;
an item surfacing module that is configured to surface one or more of the items based on the accessed referral information.

2. The system of claim 1, wherein the referral module is configured to access referral information associated with rankings assigned to the items that satisfy the search criteria and based on a quantity of referrals received by the network-based publication system from viewers of product description information associated with the items; and
wherein the item surfacing module is configured to surface items having at least a predetermined ranking.

3. The system of claim 1, wherein the referral module is configured to access referral information associated with rankings assigned to the items that satisfy the search criteria and based on a quality metric assigned to viewers of product description information associated with the items that provided referrals for the items; and
wherein the item surfacing module is configured to surface items having at least a predetermined ranking

4. The system of claim 1, wherein the referral module is configured to access referral information that is based on referrals received from viewers of product description information associated with the items provided by the network-based publication system.

5. The system of claim 1, wherein the item surfacing module is configured to surface items that have received one or more referrals from viewers of product description information associated with the items within a certain time period.

6. The system of claim 1, wherein the request module is configured to receive the request from a user of the network-based publication system; and wherein the item surfacing module is configured to surface items that have received one or more referrals from viewers of product description information associated with the items based on characteristics associated with the user of the network-based publication system.

7. The system of claim 1, wherein the referral module is configured to access referral information for items provided by two or more different network-based publication systems.

8. The system of claim 1, further comprising:
a publication module that is configured to publish, via a user interface provided by the network-based publication system, product description information associated with the one or more surfaced items along with product description information for other items provided by the network-based publication system that satisfy search criteria associated with the received request.

9. The system of claim 1, further comprising:
a publication module that is configured to publish, via a user interface provided by an application associated with referrals aggregated from multiple network-based publication systems, product description information associated with the one or more surfaced items.

10. A method, comprising:
receiving a request for one or more items provided by a network-based publication system that satisfy search criteria associated with the received request;
accessing referral information for items provided by the network-based publication system that satisfy the search criteria;
surfacing one or more of the items based on the accessed referral information.

11. The method of claim 10, wherein accessing referral information for items provided by the network-based publication system that satisfy the search criteria includes accessing referral information associated with rankings assigned to the items that satisfy the search criteria and that are based on a quantity of referrals received by the network-based publication system from viewers of product description information associated with the items; and
wherein surfacing one or more of the items based on the accessed referral information includes surfacing items having at least a predetermined ranking.

12. The method of claim 10, wherein accessing referral information for items provided by the network-based publication system that satisfy the search criteria includes accessing referral information associated with rankings assigned to the items that satisfy the search criteria and that are based on a quality metric assigned to viewers of product description information associated with the items that provided referrals for the items; and
wherein surfacing one or more of the items based on the accessed referral information includes surfacing items having at least a predetermined ranking.

13. The method of claim 10, wherein accessing referral information for items provided by the network-based publication system that satisfy the search criteria includes accessing referral information that is based on referrals received from viewers of product description information associated with the items provided by the network-based publication system.

14. The method of claim 10, wherein surfacing one or more of the items based on the accessed referral information includes surfacing items that have received one or more referrals from viewers of product description information associated with the items within a certain time period.

15. The method of claim 10, wherein receiving a request for one or more items provided by a network-based publication system that satisfy search criteria associated with the received request includes receiving the request from a user of the network-based publication system; and wherein surfacing one or more of the items based on the accessed referral information includes surfacing items that have received one or more referrals from viewers of product description information associated with the items based on characteristics associated with the user of the network-based publication system.

16. The method of claim 10, wherein accessing referral information for items provided by the network-based publication system that satisfy the search criteria includes accessing referral information for items provided by two or more different network-based publication systems.

17. The method of claim 10, further comprising:
publishing, via a user interface provided by the network-based publication system, product description information associated with the one or more surfaced items along with product description information for other items provided by the network-based publication system that satisfy search criteria associated with the received request.

18. The method of claim 10, further comprising:
publishing, via a user interface provided by an application associated with referrals aggregated from multiple network-based publication systems, product description information associated with the one or more surfaced items.

19. A computer-readable storage medium whose contents, when executed by a computing system, cause the computing system to perform operations, comprising:
receiving a referral of an item from a viewer of product description information associated with the item presented by a network-based publication system;
determining the item has been purchased by a user of the network-based publication system; and
performing an action associated with the viewer that provided the referral of the item based on the determination that the item has been purchased.

20. The computer-readable storage medium of claim 19, wherein performing an action associated with the viewer that provided the referral of the item includes providing a reward to the user that provided the referral of the item.
